(19) United States
(12) Patent Application Publication
(10) Pub. No.: US 2007/0063099 A1
(43) Pub. Date: Mar. 22, 2007

(54) Buoyancy-assisted air vehicle and system and method thereof

(75) Inventor: Richard Charles Holloman JR., Atlanta, GA (US)

Correspondence Address: GEORGE R. REARDON, 3356 STATION COURT, LAWRENCVILLE, GA, 30044, US

(73) Assignee: Mobodyne Corporation

(21) Appl. No.: 11/230,695

(22) Filed: Sep. 20, 2005

(51) Int. Cl. B64C 30/00

(52) U.S. Cl. 244/117 R

(57) ABSTRACT

A method and system for air flight is disclosed. The blended lifting body system is comprised of a lift module, a propulsion module, a payload module and a control system. The control system morphs the other modules through variable buoyancy, internal structures and a flexible exterior, and varies biomimetic oscillation in the propulsion module in order to facilitate takeoff, flight and landing.

### FIELD OF THE INVENTION

The present invention relates to the field of buoyancy-assisted air vehicles. In particular, the present invention relates to buoyancy-assisted winged air vehicles capable of door-to-door variable-vector lift air travel by means of assuming various aerodynamic shapes propelled by biomimetic empennage and fin/fluke oscillations.

### BACKGROUND OF THE INVENTION

Currently, the sky is virtually empty of buoyancy-assisted air vehicles. Even though they are capable of vertical lift and do not require runways for operations, the rigid shape and high volume of airships create significant operating limitations. Skin friction and drag make them vulnerable, due to slow speed and light aerodynamic loading, to winds and electrical storms, especially during takeoff and landing operations. This, in addition to significant lift gas management challenges, results in an impractical and expensive mode of transport, especially for individual users in an urban environment. In short, existing buoyancy-assisted air vehicles are too large and too slow for door-to-door personal air vehicle application. Legacy winged aircraft require runways.

Individuals desiring rapid travel by controlled flight are basically limited to legacy winged aircraft design variants. Individuals utilizing these solutions typically experience feelings of being cramped, confined, and vulnerable due to the sense that the surrounding rigid superstructure is fragile and small and the vehicle easily disabled, especially with loss of lift caused by an engine incident during flight.

Individuals electing to utilize an airship or winged aircraft also typically must travel by another mode of transportation in order to utilize these vehicles, and then store and operate these vehicles at a location requiring specialized support infrastructure away from home, resulting in substantial extra time and operating expense.

Finally, the means of propulsion for current solutions are typically expensive, noisy, require frequent specialized maintenance, and involve volatile and toxic substances.

Previous attempts to solve these and other problems include the following:

U.S. Pat. No. 5,005,783, issued to Taylor, discloses a variable geometry airship—has a helium-filled flexible envelope and tighten-able adjusting lines which can be released.

U.S. Pat. No. 6,848,647, issued to Albrecht, discloses a buoyant and semi-buoyant/pressurized fluid stream jet vehicle, includes internal skeletal mechanisms which are modified to change their shape, and centralized control agents to manage vehicle functions.

U.S. Pat. No. 4,012,016, issued to Davenport, discloses an autonomous variable density aircraft which has a body formed by hinged rigid panels with flexible partitions forming interior compartments.

U.S. Pat. No. 3,970,270, issued to Pittet, Jr. discloses a light gas filled aircraft wing which has aerodynamic configuration wing element with cells filled with lighter than air gas.

The present invention most closely resembles the Category B Partial Lift Augmentation class of air vehicles described in the authoritative work by Khoury and Gillett, Airship Technology, p. 478. While such studies and other prior art have attempted to solve the above mentioned problems, none have integrated biomimetic empennage and fin/fluke oscillation as a method of propulsion for a shape-morphing, buoyancy-assisted aerodynamic winged air vehicle that can deliver true practical vertical takeoff and landing door to door air travel that is safe, quiet, economical, easy to use, and environmentally friendly.

Therefore, a need exists for an improved air vehicle and system and method of flight.

The foregoing patent and other information reflect the state of the art of which the inventor is aware and are tendered with a view toward discharging the inventor's acknowledged duty of candor in disclosing information that may be pertinent to the patentability of the present invention. It is respectfully stipulated, however, that the foregoing patent and other information do not teach or render obvious, singly or when considered in combination, the inventor's claimed invention.

### BRIEF SUMMARY OF THE INVENTION

The general purpose of the present invention, which will be described subsequently in greater detail, is to provide a new air vehicle, and system and method thereof for door to door flight requiring no ground infrastructure that is safe, economical, and easy to operate. In particular, the present invention relates to controlled morphing of elements of a winged air vehicle coupled with variable buoyancy and biomimetic empennage and fin/fluke oscillation, in order to facilitate full-freedom vertical and horizontal flight operations, in other words, by providing a modular, hybrid, morphing dynastat air vehicle. The vehicle also features unique flight upset prevention/recovery characteristics.

The present invention is comprised of a lift module, an empennage propulsion module, and a payload module. Each of these modules is operable for controlled, dynamic changes in shape, or morphing. Each of these modules is capable of partial buoyancy and each utilizes internal and external structures and flexible skin to enable morphing of the module. The present invention is further comprised of means for releasable attachment of these modules to each other, to enable on-the-ground swapping out of different embodiments of each module. The present invention is further comprised of a control system operably connected to each of the modules to facilitate the morphing needed for the different aspects of flight.

The lift module changes, or morphs, its aerodynamic shape during takeoff, climb, cruise, descent and landing by expanding or contracting its volume and dynamic lift via use of internal buoyant gases, two-way valves, control tethers and expansion segments. The lift module's fundamental design is a swing-wing stingray-like blended lifting body shape. The lift module is of clamshell design and changes internal shape or morphs similar to an accordion or bellows.

The interchangeable morphing lift module also comprises a deployable pneumatic telescoping flexible skeletal system which in turn controls the dimensions of its left and right wing segments, and expansion envelope. The lightweight composite clamshell comprises an expansion bellows envelope that is comprised of an array of variable inflation bubble wrap foam segments and steam/hydrogen chambers.

The left and right wings and expansion bellows envelope are telescoping extensions of the blended lifting body that expand, contract, extend, and retract according to forces applied by their respective skeletal system components, lifting gas adiabatic changes, and control system. In-flight two-axis roll and pitch control is effected primarily by simultaneous or differential change of the lift module wing shapes in elevon fashion.

A system of variable dimension lifting gas-impregnated bubble wrap foam cell segments and lift gas chambers in all three modules utilize multiple lift gas types for vehicle buoyancy when under relaxed structural pressure and augment airframe rigidity when compressed. Because force (aerodynamic and/or mechanical) is required to maintain the cruise speed compressed configuration, the relaxed expanded configuration is readily available for flight upset prevention/recovery in the event of engine failure or other emergency.

A system of deployable flexible pneumatic airframe skeletal segments (spine and spars, and stringers) responds to lifting gas expansion and compression to extend or retract the left and right wing extensions, and variably open and close the expansion envelope clamshell, and engages the propulsion module extension and actuation system. These skeletal members comprise a closed lifting gas management system that exchanges lifting gas with the bubble wrap foam segments as the fundamental means of in-flight vehicle integrity and buoyancy regulation, augmented by the lift module bellows chambers.

The propulsion module morphs similar to the way that aquatic animals morph their bodies, particularly their tails, according to thrust needed at the time. To patrol like a shark, the vehicle spine relaxes and the tail oscillates slowly for greater maneuverability. For increased speed, the module spine stiffens to move the locus of oscillation aft and oscillate selected portions of the spine more rapidly. At highest speeds, the caudal oscillation is principally in the aft-most tail fin/fluke segment with highest oscillations per minute (OPM) frequency. The morphing of the propulsion module generally consists of lengthening and stiffening of its spine element by means of gas compression, coupled with corresponding changes in the rate of engine power-actuated oscillation, and variations in final tail section sweep and aspect ratio.

The propulsion module empennage is comprised of a series of articulated buoyant segments, culminating in a rearmost tailfin/fluke, which are attached symmetrically to the propulsion module spinal structure. A flexible skin covers the empennage for drag reduction. The propulsion module actuation system employs either legacy or purpose-built devices and principles to convert engine assembly power into biomimetic oscillations of the propulsion module segments and rearmost segment in fishtail/cetacean fluke and bird-wing fashion to provide dynamic thrust.

Heat tapped from the engine assembly or otherwise generated passes through a heat exchanger to cause expansion of onboard lifting gas and introduction of heated ambient air or steam/hydrogen, thereby effecting greater lift module shape change and inflation of the lifting module expansion envelope bellows. Alternatively, lift gas cycles through an engine-mounted heat exchanger. The combined buoyant force of the expanded lift module, lifting gas, and expansion envelope, supplemented by dynamic thrust and lift generated by the propulsion module, is the primary means of sustaining lift force during vehicle takeoff and other primarily buoyant phases of flight. During primarily dynamic lift phases of flight, the expansion envelope nests to varying compactness according to the metered re-pressurization of lift gas for airframe shaping and/or engine fuel or expulsion of comprised heated air or steam/hydrogen. The lift module morphs into a roughly stingray wing shape by means of mechanically induced pneumatic pressure, aerodynamic forces from increased airspeed, and deployment of the skeletal truss system. Resultant form drag reductions allow for increased forward speed and minimize energy required for the propulsion module to maximize forward thrust and dynamic lift.

Propulsion module morphing is comprised of a variable spinal stiffness control system that manages oscillation frequency and amplitude of the articulated buoyant segments and rearmost segment for airspeed and maneuverability control; its tail shape control system manages tailfin/fluke sweep and aspect ratio to control laminar flow, boundary layer, wake and vortices.

In addition to the flexible skin covering the articulated propulsion module segments to minimize parasite drag, a nacelle shroud in various present invention embodiments encloses the oscillating tail surfaces, further enhancing laminar flow, increasing thrust by containing and directing the compressed tailfin/fluke propulsion output and vortices, and preventing contact between the oscillating propulsion module and external objects.

The propulsion module spinal structure may be comprised of hollow flexible telescoping segments that dynamically extend and retract the assembly of propulsion segments, and stiffens according to mechanical and pneumatic forces to vary the propulsion module locus of oscillation. Alternatively, the propulsion assembly may comprise a spinal ribbon of flexible high strength materials such as shape memory alloys or durable metallized or composite fabric supporting reciprocating chemical muscle actuators. The buoyant propulsion segments may additionally be serially attached to each other at their upper and lower extremities to dampen oscillation vibrations and to reduce dynamic propulsion stress on the spinal structure and vehicle airframe. The locus of propulsion is centerline focused and gimbaled 90 degrees vertically and laterally to enable precise 360 degrees of thrust vector directional control, employing a transmission air bridge to prevent conduction of oscillation forces forward to the payload module.

The morphing payload module is comprised a lightweight shape-controlling skeletal system and a cockpit or control center served by an electrical system to manage the control actuation system. The payload module morphs both horizontally and vertically. In slow-flight or hover mode, the payload module is expandable to allow occupant mobility, to include latrine use and sightseeing within the passenger chamber of the payload module. When increased air speed is desired, the payload module is contracted to create a more compact aerodynamic shape for less drag. The payload module is further comprised of an undercarriage structure with foldable legs and an elbowed retractable shock-absorbing landing gear. This undercarriage structure may be enabled for grasping or carrying an external payload, for attaching to a surface or aloft mooring structure, and for elevation during takeoff for vertical thrust ground clearance. The foldable legs may also comprise retractable caster wheels. For one simple human-powered embodiment of the current invention, the user may constitute the payload module while strapping on the lift and propulsion modules in backpack and bicycle fashion respectively. Buoyant conformal bubble wrap foam segments may be attached to the apparatus for additional lift and operational safety.

Each of the three modules utilize lifting gas impregnated bubble wrap foam comprised of interconnected open or independent closed cells, with or without self-healing fabric external shells. This feature enables the present invention to absorb the energy from bumping into blunt or sharp objects without compromising airworthiness or structural integrity and shielding the vehicle frame and occupants from impact forces.

The control system is operably connected to the lift, payload and propulsion modules and morphs these modules based on the flight characteristics desired, e.g. buoyancy increase or decrease; module expansion, contraction, extension or retraction; biomimetic oscillation frequency and amplitude increase or decrease; and aerodynamic shape change, to match the desired flight characteristics.

One advantage of the present invention is that it is a hybrid of the best features of airships and airplanes. It attains the advantages of airships, helicopters and airplanes, while overcoming their respective disadvantages. Through morphing and biomimetic propulsion, the present invention combines continual variability in shape and buoyancy with energy efficient propulsion.

Another advantage of the present invention is fulltime transitional vertical glide that enables no-ground-run takeoff and landing, and therefore door-to-door operations, without the historically vast expenses of energy, land use and infrastructure support of runway required by most air vehicles. Because it is airtight, the present invention can therefore also easily operate to and from the surface of bodies of water. This multi-modal advantage allows trans-mission military or government employment of manned or unmanned air vehicles in maritime, standoff, overhead, and denied airspace operations.

Another advantage of the present invention is that the three basic modules firmly attach to each other by means of a universal connection, like quick-change connectors on racecars. This allows for interchangeable lift, propulsion or payload modules for a wide range of personal, commercial, and government applications.

Another advantage of the present invention is that the loss of power causes the lift module to revert to its fail-safe mode of buoyant expanded state—a major safety and vehicle survivability factor. The currently popular ballistic parachute recovery system for small aircraft would be a redundant option as the present invention prevents flight upset and recovers from inadvertent upset by reverting to its expanded configuration and continuing normal controlled gradual gliding flight to a safe and optimal landing site.

Another advantage of the present invention is that it generates minimal vorticular wingtip wake, propwash, or jetwash, as compared to a propeller or turbine, and minimal downwash as compared to helicopters. In addition to enabling outdoor congested urban flight operations, this advantage allows operations in enclosed facilities, such as stadiums, auditoriums, and shopping malls.

Another advantage of the present invention is that it can sustain very long loiter and persistent hover time, both in manned and unmanned embodiments, made possible by its very low energy consumption due to buoyancy. Lightness and unique design also enable practical human-powered variants of the present invention.

Another advantage of the present invention is that its fold-ability allows easy configuration for lightweight routine operations from a rooftop or vehicle-top platform, partial folding for overnight parking or securing for inclement weather in a standard two-car garage, and more compact folding for airborne or seaborne deployment and for long-term storage and shipping. This same advantage accrues to field deployment for unmanned embodiments.

Another advantage of the present invention is that it is easy to use and compatible with autonomous and semi-autonomous control systems, thereby requiring minimal training and certification, and readily acceptable by heretofore disadvantaged populations for leap-ahead transportation solutions. It is therefore compatible with a wide range of unmanned vehicle payload applications and easily configured for operation by the physically handicapped.

Another advantage of the present invention is that because of its simpler propulsion, conducive to rapid modular robotic unibody manufacturing and less expensive materials, and its reliance on buoyant lift, it is less expensive to produce, acquire and operate than a traditional aircraft. As a result, the present invention promotes rapid after-market technology upgrades and user customization while providing in-flight range and specific fuel consumption performance far superior to like aircraft in all its scalable embodiments.

Another advantage of the present invention is that its biomimetic propulsion, powered by dual-use lift gas/alternative non-fossil fuels and technologies, dramatically reduces transportation noise and environmental impact, meeting strict urban standards while requiring minimal ground infrastructure, as compared to turbine and propeller aircraft. Extensive adoption of the present invention to supplant legacy transportation modes and infrastructure will generate transformational improvements in air quality and land use while enabling off-grid transportation autonomy for populations worldwide.

Another advantage of the present invention is that its larger-scale embodiments, as well as multiples of the present invention connected together, may be operated in scheduled and linked shipping configurations similar to trucks, trains, barges, and cargo aircraft, generating major commercial transportation savings in crew, navigation, and fuel expenses.

Another advantage of the present invention is that it can be introduced in add-on modular kit form to compatible legacy aircraft to incrementally advance somewhat diminished but still worthwhile benefits compared to purpose-built present invention embodiments. These include the hybridized benefits of lighter-than-air and heavier-than-air aircraft such as near vertical liftoff, near point-to-point flight at a wide range of altitudes and airspeeds, and short and extremely short takeoff and landing operations. Similarly, basic kit embodiments of the present invention are conducive to distributed manufacturing for licensed production of local market-customized air vehicles.

Another advantage of the present invention is that it overcomes limitations of aerostatic flight vehicles, e.g. dirigibles, blimps, and balloons, such as wind limits, limited cruise speed, need for launch and recovery infrastructure, and shape and gas management challenges induced by altitude and speed change. It thereby enables precise delivery and low-cost air-launch of payloads, replacing parachute delivery systems for personnel or cargo by trading altitude energy for distance, speed, endurance, maneuverability and long-life reusability.

Another advantage of the present invention is that it overcomes limitations of legacy powered aerodynamic flight vehicles, e.g. helicopters and airplanes, such as disruptive downwash, reliance on airspeed over an airfoil to generate lift and the resultant need for a cleared ground run surface, difficulty maintaining a fixed position over the ground, and catastrophic vulnerability to loss of motive power.

Another advantage of the present invention is that whether operated as a manned or unmanned vehicle, it enjoys greatly reduced signal and reflective detectability due to its minimal operating noise, heat, and wake, and energy-absorbent construction.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further objects and advantages of the present invention will be apparent from the following detailed description of a presently preferred embodiment which is illustrated schematically in the accompanying drawings.

### BRIEF DESCRIPTION OF THE SEVERAL VIEWS OF THE DRAWINGS

Other advantages and features of the invention are described with reference to exemplary embodiments, which are intended to explain and not to limit the invention, and are illustrated in the drawings in which:

FIG. 1 is a perspective view of a Modular Hybrid Morphing Dynastat Air Vehicle according to a preferred embodiment of the present invention.

FIG. 2 is a right side plan view of a Modular Hybrid Morphing Dynastat Air Vehicle according to a preferred embodiment of the present invention.

FIG. 3 is a right side plan view of a Modular Hybrid Morphing Dynastat Air Vehicle, showing extension of the front legs of the wheel assembly in preparation for lift off according to a preferred embodiment of the present invention.

FIG. 4 is a left side plan view of a payload module and propulsion module of a Modular Hybrid Morphing Dynastat Air Vehicle according to an embodiment of the present invention.

FIG. 5 is a top down view of a payload module and propulsion module of a Modular Hybrid Morphing Dynastat Air Vehicle according to an embodiment of the present invention.

FIG. 6 is a perspective view of a payload module and propulsion module of a Modular Hybrid Morphing Dynastat Air Vehicle according to an embodiment of the present invention.

FIG. 7 is a left side plan view of a Modular Hybrid Morphing Dynastat Air Vehicle with a lift module fully compressed according to an embodiment of the present invention.

FIG. 8 is a left side plan view of a Modular Hybrid Morphing Dynastat Air Vehicle with a lift module in a partially expanded position according to an embodiment of the present invention.

FIG. 9 is a left side plan view of a Modular Hybrid Morphing Dynastat Air Vehicle with a lift module in a fully expanded position showing internal structure according to an embodiment of the present invention.

FIG. 10 is a bottom perspective view of a Modular Hybrid Morphing Dynastat Air Vehicle with a lift module in a fully expanded position according to an embodiment of the present invention.

FIG. 11 is a back plan view of a Modular Hybrid Morphing Dynastat Air Vehicle with a lift module in a fully expanded position according to an embodiment of the present invention.

FIG. 12 is a front plan view of a Modular Hybrid Morphing Dynastat Air Vehicle with a lift module in a fully expanded position according to an embodiment of the present invention.

FIG. 13 is a bottom perspective view of a Modular Hybrid Morphing Dynastat Air Vehicle with a lift module in a fully expanded position according to an embodiment of the present invention.

FIG. 14 is a left side plan view of a Modular Hybrid Morphing Dynastat Air Vehicle with a lift module in a nearly full expanded position according to an embodiment of the present invention.

FIG. 15 is a left side plan view of a Modular Hybrid Morphing Dynastat Air Vehicle showing the internal structure of a lift module according to an embodiment of the present invention.

FIG. 16 is a top side plan view of a Modular Hybrid Morphing Dynastat Air Vehicle with a lift module in a fully expanded position according to an embodiment of the present invention.

FIG. 17 is a left side plan view of a Modular Hybrid Morphing Dynastat Air Vehicle showing a lift module, payload module and propulsion module according to an embodiment of the present invention.

FIG. 18 is a perspective view of a Modular Hybrid Morphing Dynastat Air Vehicle showing a propulsion module in a shortened position according to an embodiment of the present invention.

FIG. 19 is a perspective view of a Modular Hybrid Morphing Dynastat Air Vehicle showing a propulsion module in a lengthened position according to an embodiment of the present invention.

FIG. 20 is a front plan view of a Modular Hybrid Morphing Dynastat Air Vehicle with a lift module in a fully expanded position according to an embodiment of the present invention.

FIG. 21 is a front plan view of a Modular Hybrid Morphing Dynastat Air Vehicle showing internal structure of the lift module according to an embodiment of the present invention.

FIG. 22 is a top perspective view of a lift module of a Modular Hybrid Morphing Dynastat Air Vehicle according to an embodiment of the present invention.

FIG. 23 is an exploded view of an internal structure for a lift module of a Modular Hybrid Morphing Dynastat Air Vehicle according to an embodiment of the present invention.

FIG. 24 is a left side perspective view of a propulsion module of a Modular Hybrid Morphing Dynastat Air Vehicle according to an embodiment of the present invention.

FIG. 25 is a left side plan view of an internal structure for a propulsion module of a Modular Hybrid Morphing Dynastat Air Vehicle according to an embodiment of the present invention.

FIG. 26 is a top plan view of an internal structure for a propulsion module of a Modular Hybrid Morphing Dynastat Air Vehicle according to an embodiment of the present invention.

FIG. 27 is an exploded view of an internal structure for a propulsion module of a Modular Hybrid Morphing Dynastat Air Vehicle according to an embodiment of the present invention.

FIG. 28 is a top perspective view of a Modular Hybrid Morphing Dynastat Air Vehicle according to an embodiment of the present invention.

FIG. 29 is a bottom plan view of a Modular Hybrid Morphing Dynastat Air Vehicle according to an embodiment of the present invention.

FIG. 30 is a top plan view of a Modular Hybrid Morphing Dynastat Air Vehicle according to an embodiment of the present invention.

### DETAILED DESCRIPTION OF THE INVENTION

Before explaining the disclosed embodiment of the present invention in detail it is to be understood that the invention is not limited in its application to the details of the particular arrangement shown since the invention is capable of other embodiments. Also, the terminology used herein is for the purpose of description and not of limitation.

An Air Vehicle is described which combines controlled morphing of elements of a winged air vehicle with variable buoyancy and biomimetic empennage and fin/fluke oscillation.

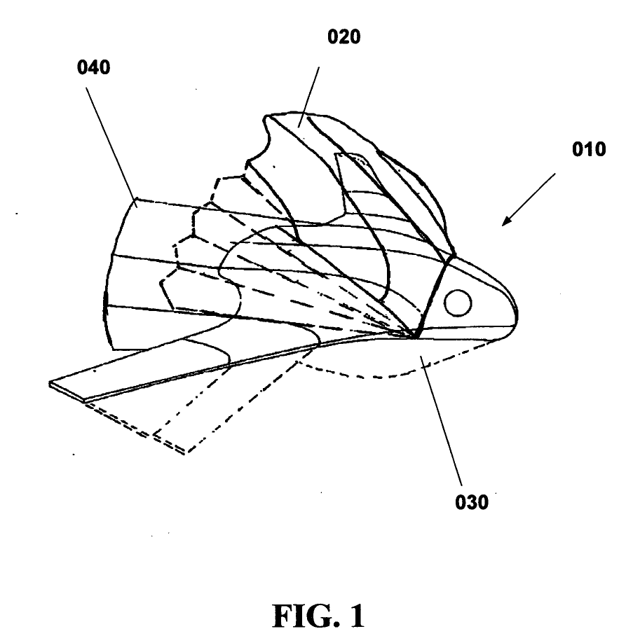

Referring now to FIG. 1, a preferred embodiment of air vehicle 010 is shown, comprised of lift module 020, payload module 030 and propulsion module 040.

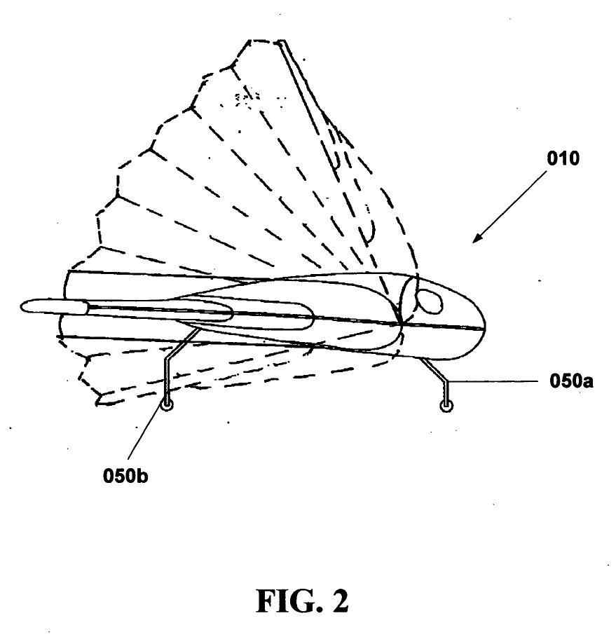

Referring now to FIG. 2, a preferred embodiment of air vehicle 010 is shown, with front wheel assembly 050a and right wheel assembly 050b.

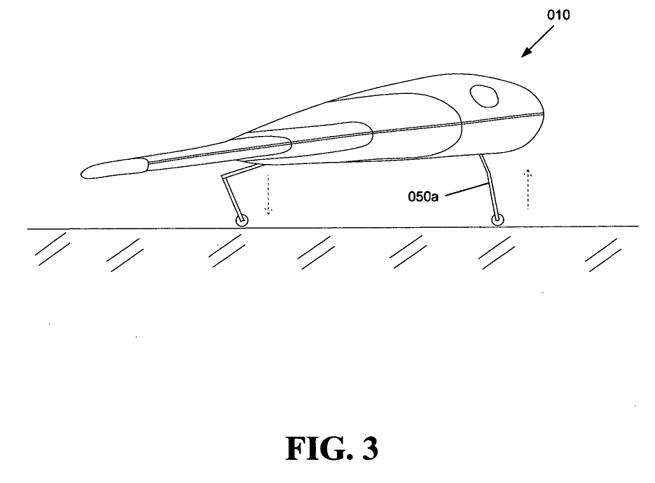

Referring now to FIG. 3, a preferred embodiment of air vehicle 010 is shown with the leg element of front wheel assembly 050a extended in preparation for lift-off.

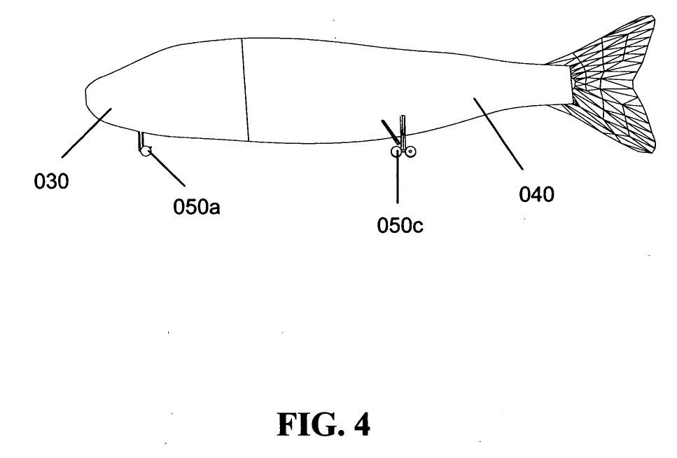

Referring now to FIG. 4, payload module 030, propulsion module 040, front wheel assembly 050a, and left wheel assembly 050c are shown.

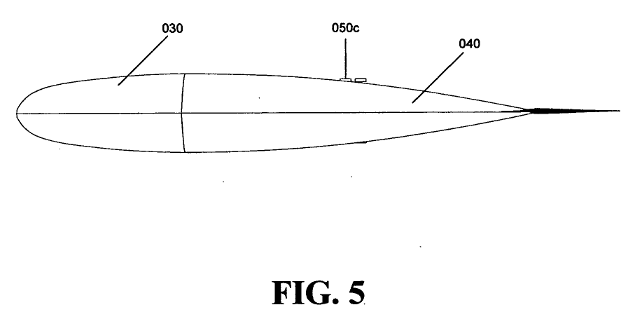

Referring now to FIG. 5 payload module 030, propulsion module 040, and left wheel assembly 050c are shown.

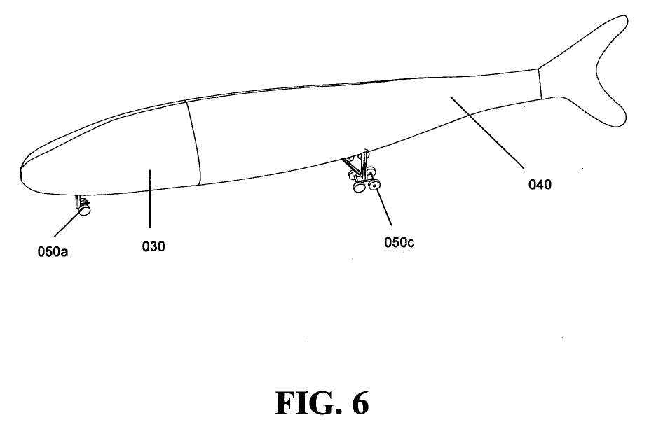

Referring now to FIG. 6, payload module 030, propulsion module 040, front wheel assembly 050a, and left wheel assembly 050c are shown. Propulsion module 040 is in an elongated state.

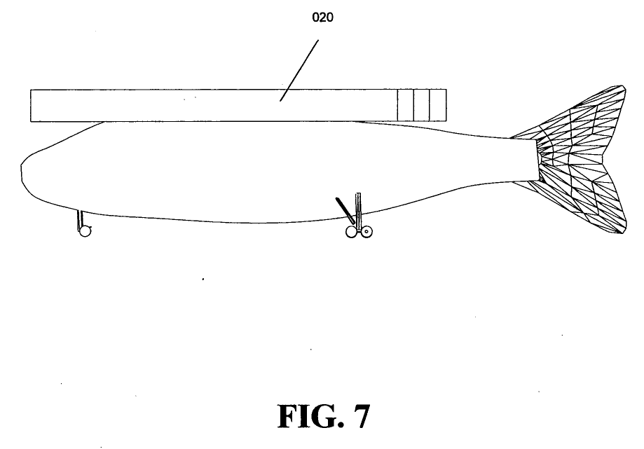

Referring now to FIG. 7 lift module 020 is shown in its compressed state.

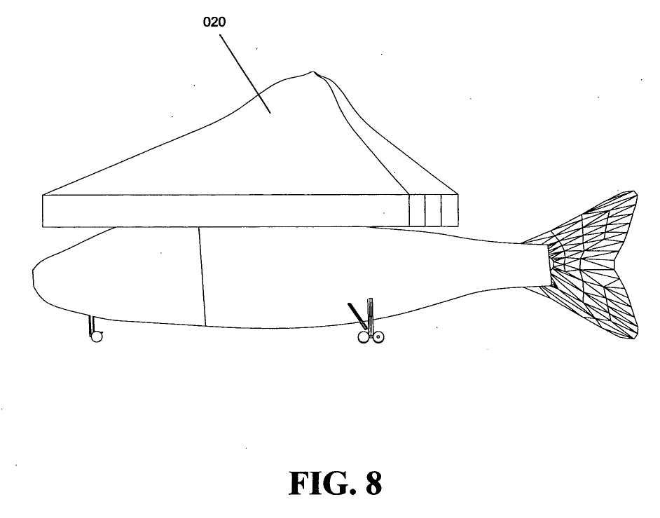

Referring now to FIG. 8, lift module 020 is shown in a partially expanded state.

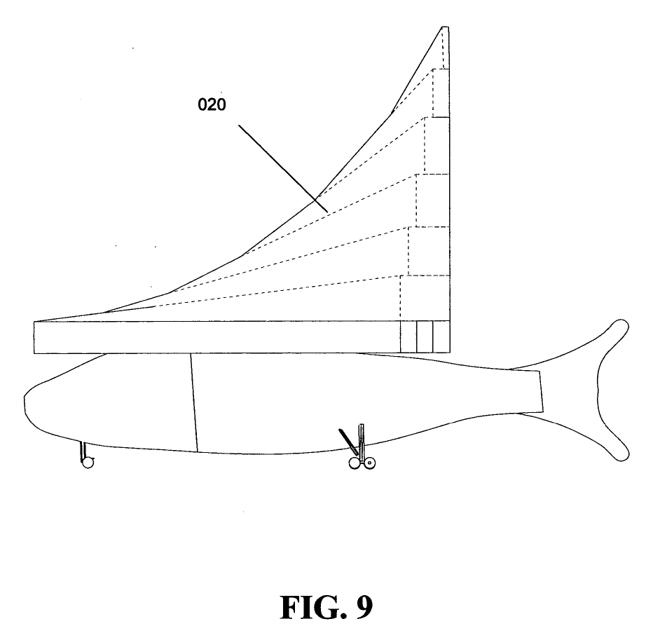

Referring now to FIG. 9, lift module 020 is shown in a fully expanded state.

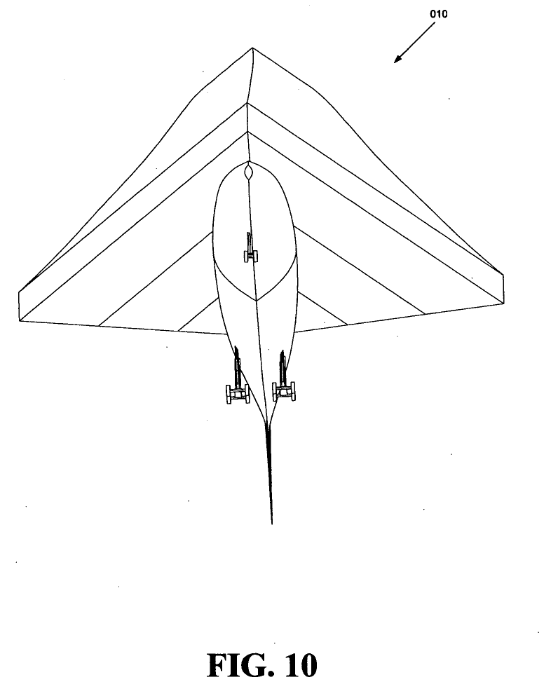

Referring now to FIG. 10, air vehicle 010 is shown from a bottom perspective view.

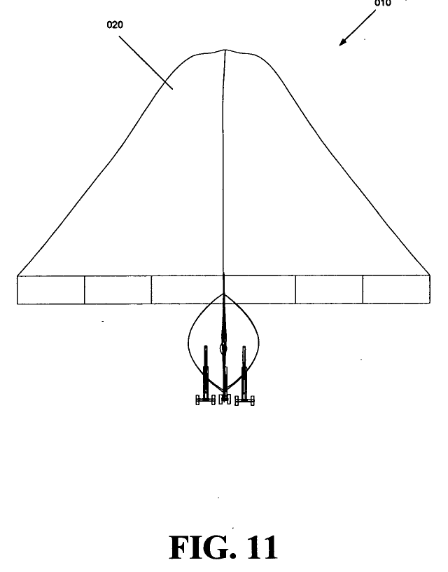

Referring now to FIG. 11, air vehicle 010 is shown with lift module 020 in a fully expanded state.

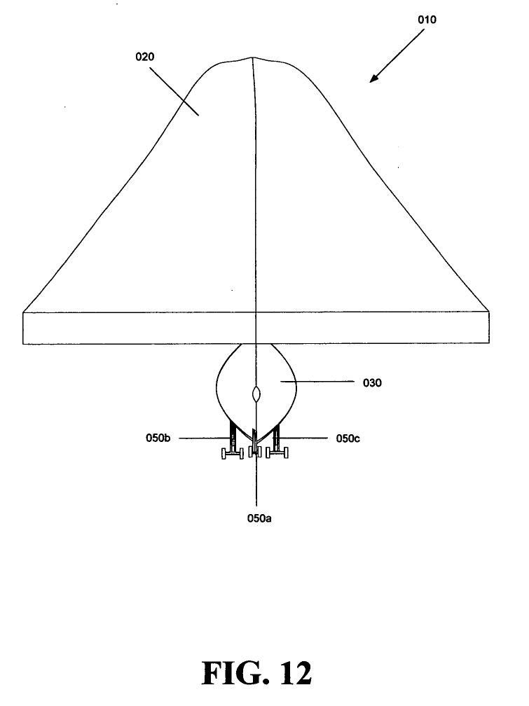

Referring now to FIG. 12, air vehicle 010 is shown with lift module 020, payload module 030, front wheel assembly 050a, right wheel assembly 050b, and left wheel assembly 050c.

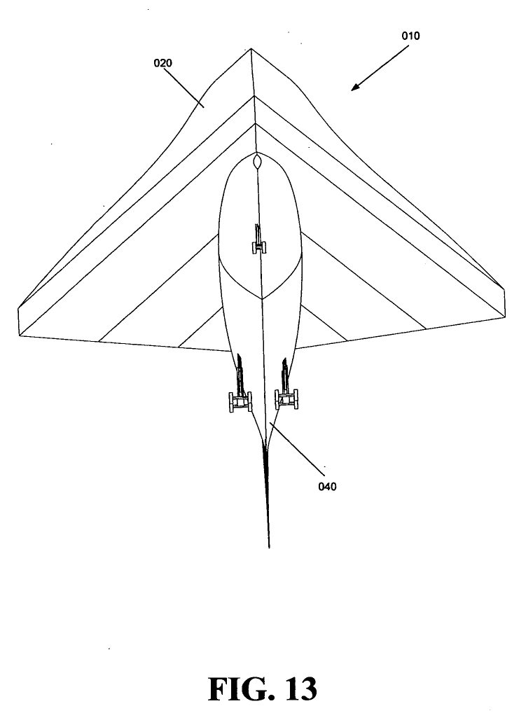

Referring now to FIG. 13, air vehicle 010 is shown with lift module 020, and propulsion module 040.

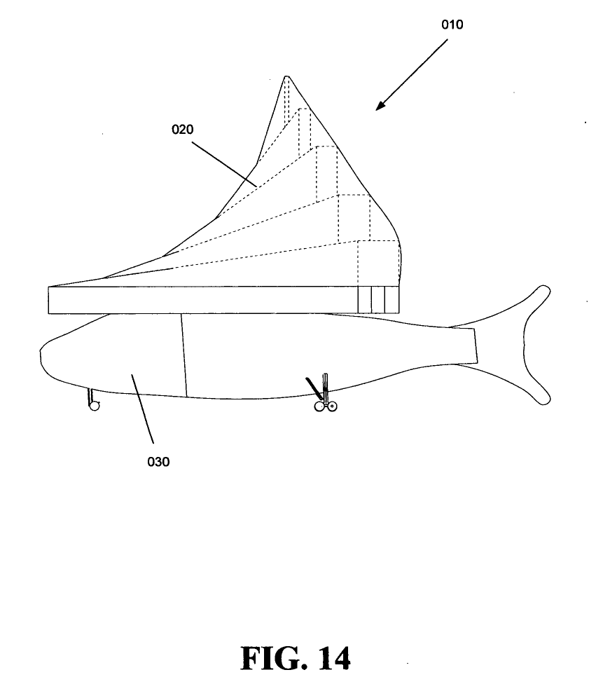

Referring now to FIG. 14, air vehicle 010 is shown with lift module 020, and payload module 030.

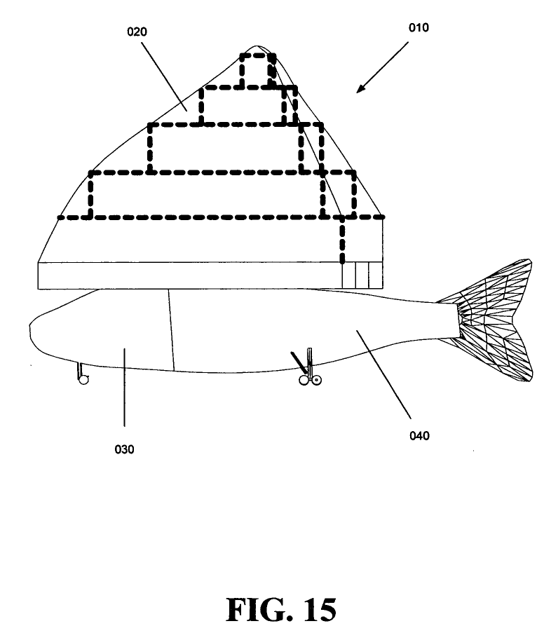

Referring now to FIG. 15, air vehicle 010 is shown with lift module 020, payload module 030, and propulsion module 040.

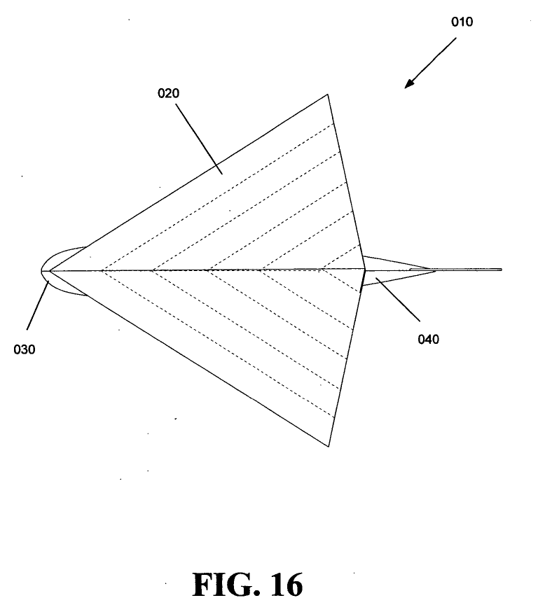

Referring now to FIG. 16, air vehicle 010 is shown with lift module 020, payload module 030, and propulsion module 040.

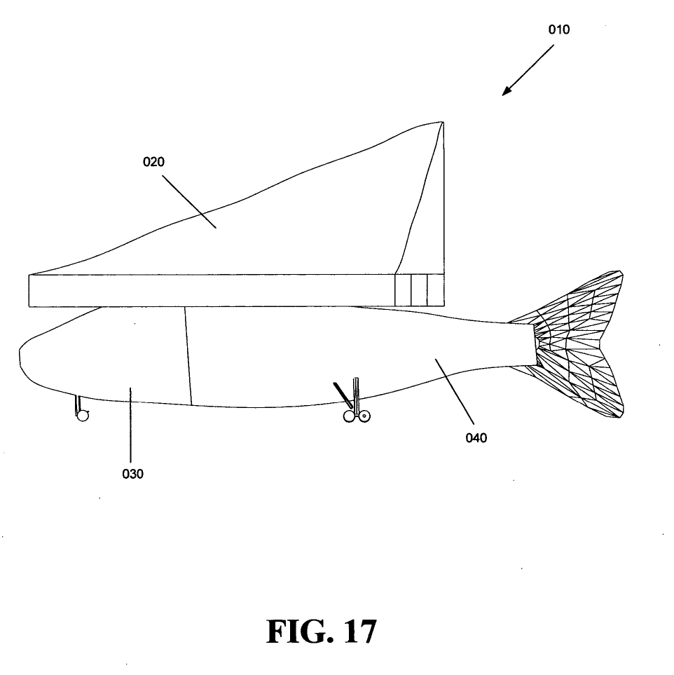

Referring now to FIG. 17, air vehicle 010 is shown with lift module 020 in a partially expanded state.

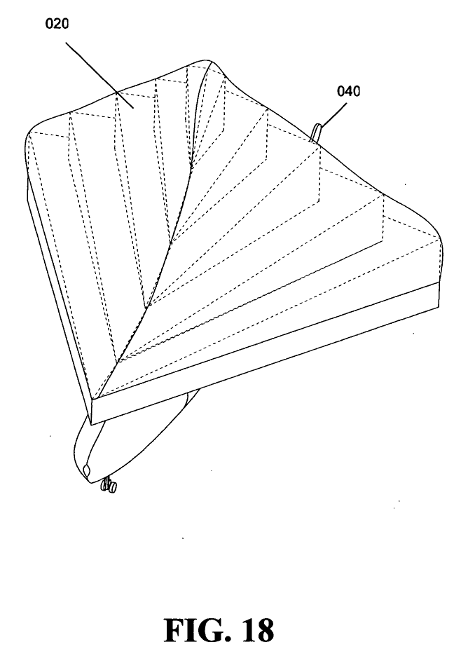

Referring now to FIG. 18, the accordion or bellows effect of lift module 020 is shown, with propulsion module 040 being in a shortened state.

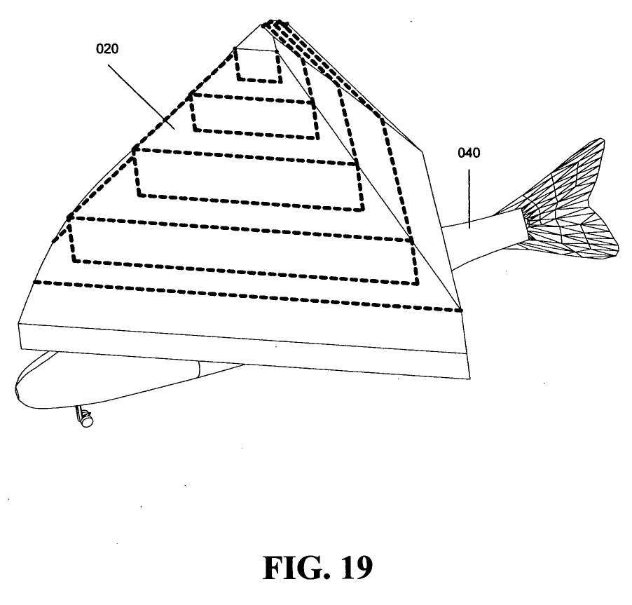

Referring now to FIG. 19, an embodiment of propulsion module 040 is shown in an elongated state.

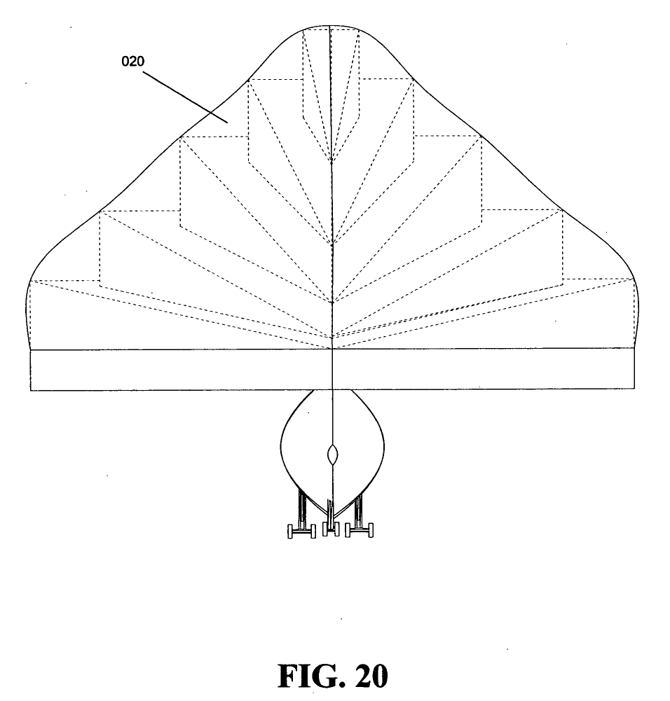

Referring now to FIG. 20, an embodiment of the internal structure of lift module 020 is shown.

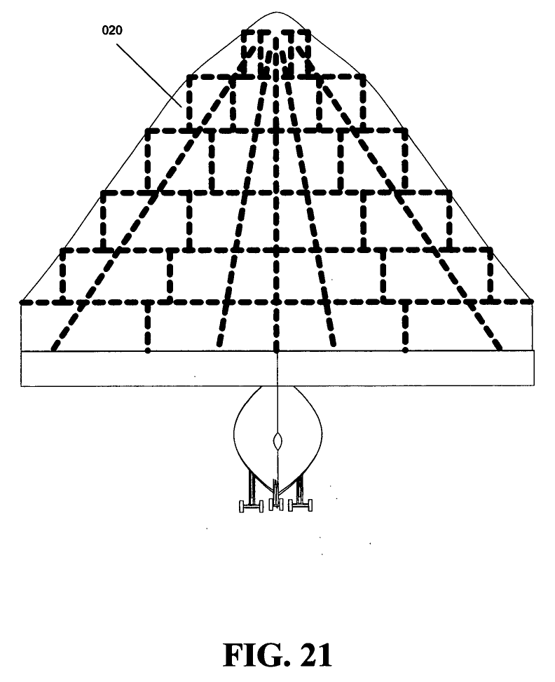

Referring now to FIG. 21, an embodiment of the internal structure of lift module 020 is shown.

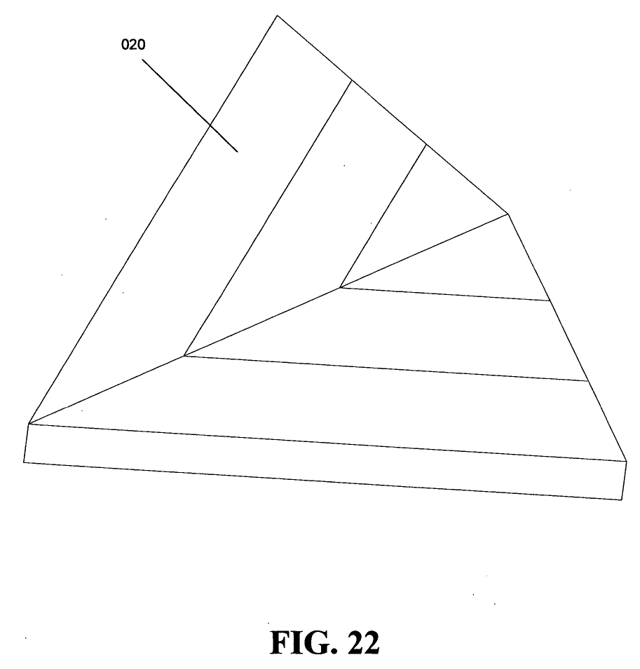

Referring now to FIG. 22, lift module 020 is shown in a compressed state.

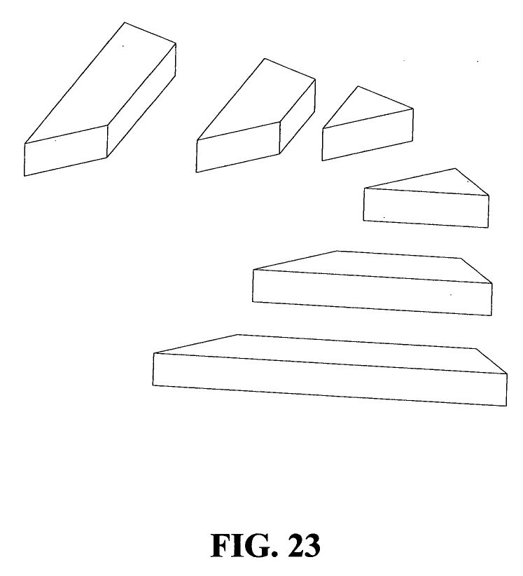

Referring now to FIG. 23, a plurality of an embodiment of the lift module elements are shown.

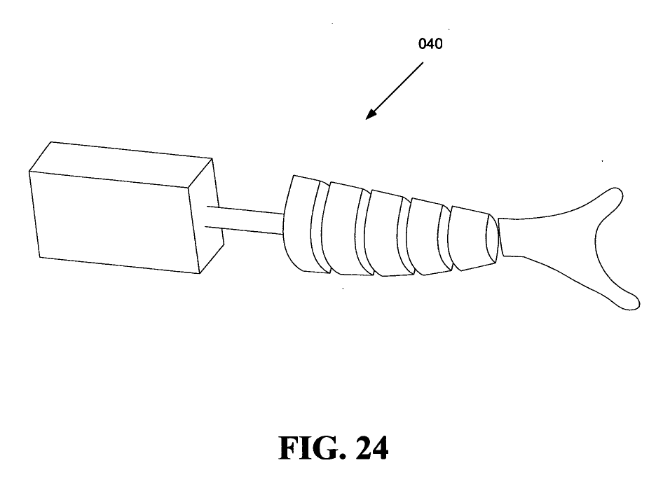

Referring now to FIG. 24, components of an embodiment of propulsion module 040 is shown.

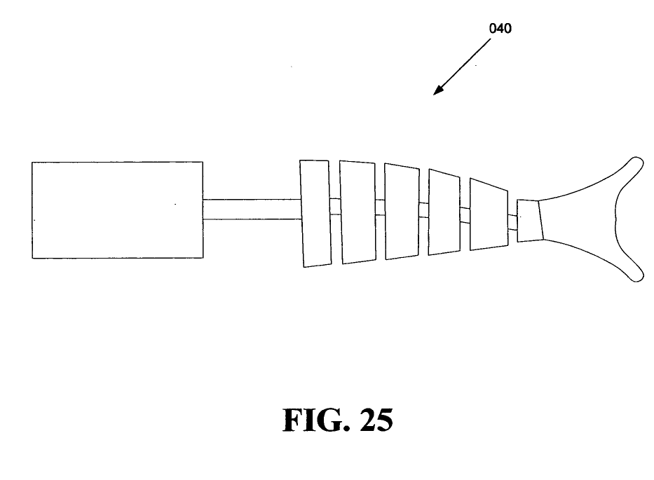

Referring now to FIG. 25, components of an embodiment of propulsion module 040 is shown.

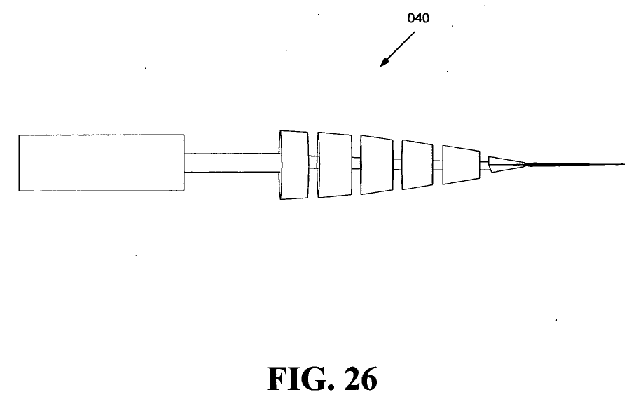

Referring now to FIG. 26, components of an embodiment of propulsion module 040 is shown.

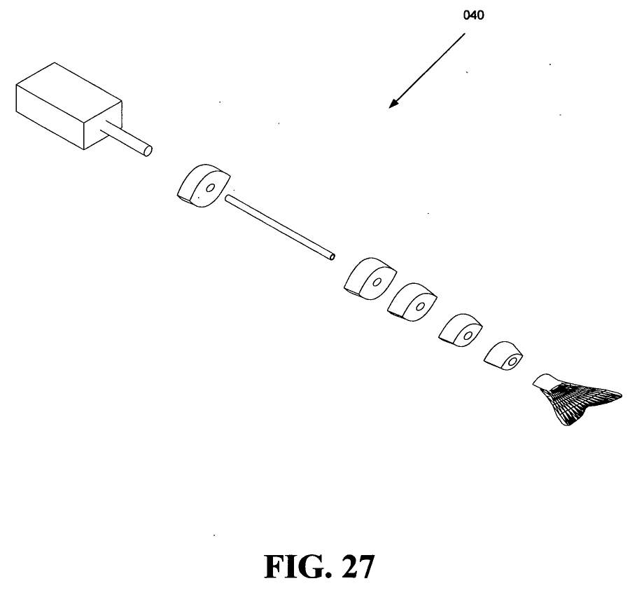

Referring now to FIG. 27, components of an embodiment of propulsion module 040 is shown.

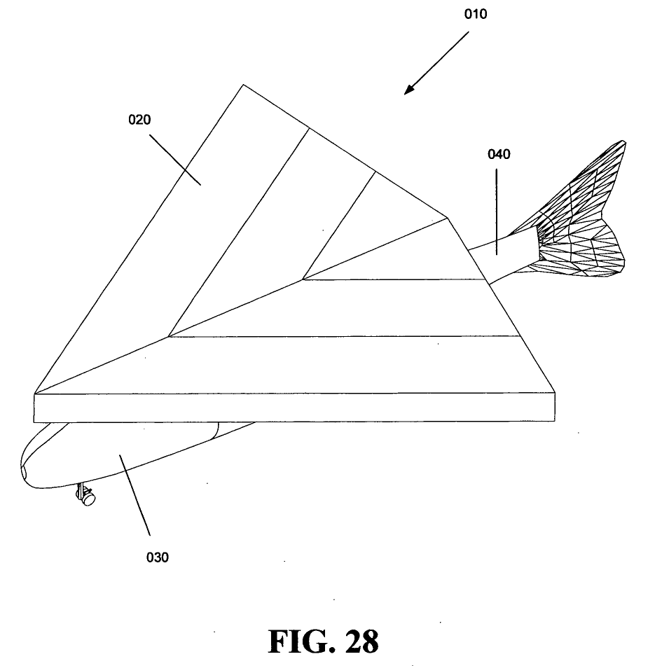

Referring now to FIG. 28, Air Vehicle 010 is shown with lift module 020, payload module 030 and propulsion module 040.

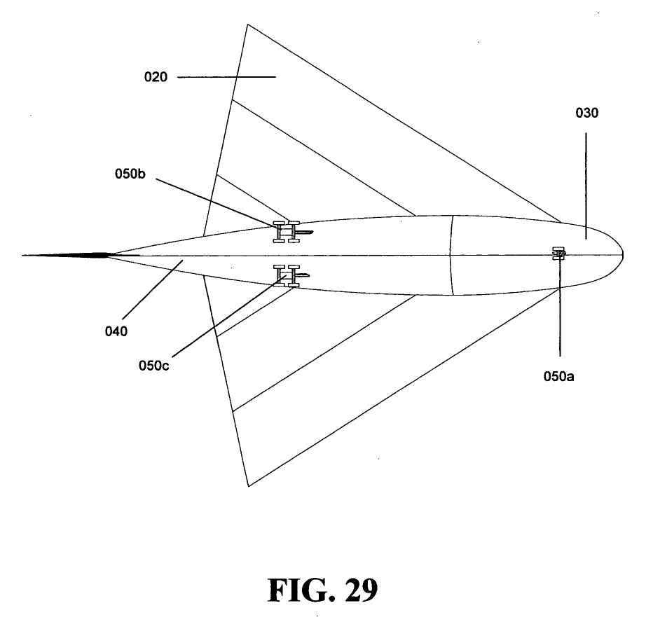

Referring now to FIG. 29, lift module 020, payload module 030, propulsion module 040, front wheel assembly 050a, right wheel assembly 050b, and left wheel assembly 050c are shown.

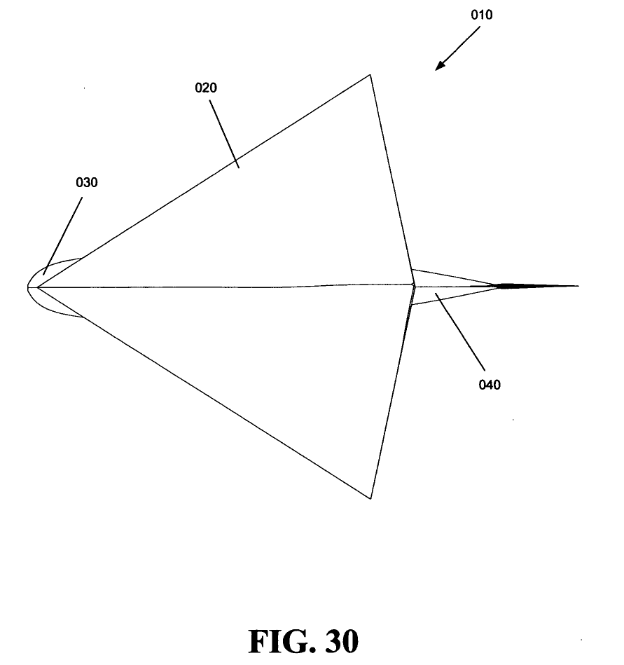

Referring now to FIG. 30, air vehicle 010 is shown with lift module 020, payload module 030 and propulsion module 040.

A very important feature of the present invention is its modularity. This is useful for flexibility in operations, ease in upgrades, and simplicity in maintenance. Not only are variants of the three primary modules interchangeable according to user preferences, but components of the modules are also highly variable in design and function.

Materials for building and operating the present invention are lift gas and envelope material variants that enclose the lift gas bubble wrap foam while maintaining high R-factor insulation for the steam/hydrogen expansion bellows layers. In addition to buoyant vehicle manufacturers, options for materials suppliers include the various companies that manufacture inflatable structures, such as truck-deployable shelters built for disaster contingencies and for the military—in addition to manufacturers of inflatable aircraft. The primary innovations in materials are the application of lift gas-fillable bubble wrap foam segments combined with lightweight insulated steam/hydrogen chambers. Conformal bubble wrap foam segments (similar to valved isothermal mattresses) will be integrated into each vehicle module with valves connecting them to the skeletal gas management system.

Overpressure membrane: an additional innovation addresses the important tasks of managing the lifting gas and reliably folding the bellows envelope. Within the outermost lightweight composite clamshell skin of the present invention is a thin inflatable layer of gas, separate from the internal structural lift gas, pressurized by bleed air from the engine to maintain a positive differential pressure. This layer backs up the internal skin holding the gas, and serves as joint ribbing to support lift module bellows shape retention during clamshell compression as the lift gas is re-pressurized back into the skeletal gas management system and the excess expansion steam/hydrogen is released.

Skeletal system: wing structural stability sufficient to withstand high positive G's is provided by an internal skeletal system. Integral within the lift module's segments of compressible and shape-recovering lift gas-impregnated bubble wrap foam, the skeletal system spine provides longitudinal vehicle strength while the spars reinforce the wings laterally. Telescoping and hollow, the skeletal components store lifting gas that when compressed serves to stiffen and extend the skeletal joints, thereby more fully deploying and strengthening the wing surface extensions and the propulsion module same.

Payload Module: the payload module has compartments of transparent conformal lifting gas bubble wrap foam segments surrounding a relatively standard aircraft cockpit area as part of the overall blended lifting body shape, providing significant impact protection for passengers while permitting wide area external visibility. In the UAV embodiments, the bubble wrap foam contributes to the combat survivability of the vehicle.

Mobometer: an instrument unique to the present invention is the Mobometer. Displaying the lift module expansion morphing state on a scale of zero to one hundred percent, zero represents the lift module's original aerodynamic shape with the expansion sections completely compressed. One hundred reflects the maximum percentage of expansion morphing possible for buoyancy-assisted flight. The buoyancy meter on the Mobometer reflects the relationship of applied buoyant force to equilibrium as determined by the total weight of the air vehicle, including payload onboard, with 1.0 on the meter equal to neutral buoyancy. Values below 1.0, such as 0.8 or 0.9, reflect weight on the wheels. For instance, a buoyant 500 lb vehicle that indicates only 50 lbs on the scales would have a Mobometer indication of 0.9 buoyancy. Values above 1.0 indicate transition to a rate of climb, including dynamic lift forces. Otherwise, the present invention cockpit will employ a standard aircraft instrument panel adapted to operational needs.

Propulsion Module: the various embodiments of the propulsion module have tail segments in number and dimensions scaled to vehicle size and performance requirements. Dimensions of the aft-most segment vary the most, similar to tailfin/fluke variants among aquatic animal species. Lift gas bubble wrap foam fills each segment attached in series to both sides of the flexible spine panel. The strong and lightweight hollow spine core functions as a lifting gas holding tank. As gas in the spine is variably pressurized by the control system and augmented by adiabatic expansion, the spine is variably stiffened for oscillation speed, frequency, and amplitude control.

Tail oscillation actuator variants for the present invention include reciprocating chemical muscles, electro-active polymers, actuation of shape memory alloys, and direct shuttle drives from hot air engines. As in aquatic animals, the stiffness of the spine will drive the primary locus, amplitude, and frequency of oscillation. Spine-controlled empennage oscillations cause a wave of motion in the following segments that maximizes both propulsive force and laminar flow efficiency while transmitting to the tailfin/fluke a whip-like increase in deflection amplitude with resultant thrust increase.

Lift Module Morphing: The lift module's fundamental design is a stingray-like blended wing lifting body shape. The clamshell lift module morphs in either an accordion fashion or a bellows fashion. In the takeoff phase, the lift module carries within its core level supporting the expansion bellows above it only the minimum volume of lifting gas required for desired partial buoyancy. When the present invention is in storage, for example, the lift module is compressed, or not expanded, so that the upper expansion bellows levels are flush with or nested within the core lift module section, and the wing sections are optionally retracted. Because all three of the present invention modules have selectable buoyancy and may be resting on lightweight retractable nylon caster wheels, a person of average strength can roll the modules out singly or connected together from storage with little effort.

When preparing for takeoff of a vehicle that has been folded for storage or transport, the user enables the expansion of the lift module, relaxing the clamshell up to allow bellows inflation and extending the wings by releasing control tethers connected to the trailing edge of each expansion segment, allowing the module to expand and be filled through two-way valves with a combination of lift gases. The core layers comprise lift gas from the closed skeletal gas management system typically retained on board the vehicle indefinitely with periodic top-off as needed. The expansion bellows layers may receive steam/hydrogen from the inflation port, variably connected to an engine bleed valve or to an external ground steam/hydrogen source. Each expansion level nests within the next lower level, so that a completely compressed expansion module morphs down into a streamlined aerodynamic stingray blended body shape nearly flush with the core lift gas lift module level.

During the transition to level flight the bellows segments within the lift module are gradually compressed down in proportion to increasing airspeed-generated dynamic lift, continually retaining an aerodynamic lifting body shape, whether bellowed or accordioned up. Simultaneously, inside the vehicle's structure, the skeletal system also pressurizes and expands telescopically, causing the pressure to increase or decrease inside the lift module segments, making each wing's leading edge more or less rigid and causing variable extension and sweep of the wings.

In the buoyancy-assisted wing lift takeoff phase, the required buoyant lift gas volume is a function of the desired up-glide angle of ascent and dynamic wing lift available. Departing contact with the surface and clear of obstacles initiates readiness for morphing. During transition to climbing dynamic lift flight, the user employs aerodynamic and mechanical forces to progressively close the lift module clamshell down to a more aerodynamic shape, thereby increasing pneumatic pressure in the lift module wing segments. A significant portion of the onboard lift gas may be contained within the core hull layers and closed skeletal spine and spar system, employing a vacuum type transfer pump that pulls/pushes the gas between the spars and gas bubble wrap foam segments. This increased pneumatic pressure in the telescoping skeletal members deploys the wings straighter out in the beginning of flight and swept back for higher airspeeds. Certain lift gases may also serve as fuel for the propulsion module.

With the resultant decrease in form drag, and increasing pneumatic pressure in the wing, the wings remain initially un-swept to maximize dynamic lift and facilitate climbing transition to cruise airspeed. Approaching cruise speed, lift module clamshell closing, aided by adiabatic gas expansion, generates maximum spar extension that in turn drives the wings back into further parasite drag-reducing swept back mode. This swing-wing shape change also allows the vehicle to accelerate to its design maximum descent speed, important to extended-range energy management flight profiles.

Payload module morphing: the payload module cabin morphs horizontally and vertically. When the air vehicle is in slow-flight or hover-flight mode, the optional aisle between seats permits moving around, such as for latrine use and sightseeing. Also, in this mode, the payload cabin's shape need not be as aerodynamic. When the user is ready to increase airspeed, and forego some of the comforts of a slow-moving air vehicle, the payload module morphs to an airplane shape, bringing closer together the seats and cabin walls and eliminating the aisle. This creates a more compact bird-like aerodynamic shape for less form and parasite drag from the passenger module. The payload module, partially buoyant due to cockpit/passenger compartment and fuselage conformal lift gas bubble wrap foam segments, may connect to the lift module skeletal gas management system. For simple human-powered embodiments, the user may constitute the payload module surrounded by morphing buoyant conformal bubble wrap foam segments.

Propulsion module morphing: the propulsion module morphs in ways that mimic aquatic animals body morphing, particularly the tail. The generation of propulsive forces by oscillating the lifting body's buoyant empennage minimizes drag while maximizing centerline thrust and generating lift. When the present invention user desires to maneuver between obstacles such as trees or buildings, such as shortly after takeoff from a high-rise office building rooftop platform, the user will typically fly slowly, allowing for reaction time to maneuver clear of nearby buildings, traffic, or other obstacles. The user will therefore maintain the present invention in loose-spine mode to allow for greater slow flight directional control. With the aircraft clear of obstacles and increasing in speed, the user will mimic aquatic animal spine stiffening to shift the locus of oscillation aft, principally to the rear-most tail segment, accelerating to a significantly higher OPM (oscillations per minute).

To prevent transmission of the oscillation motion or vibration to the payload module, the connection between the propulsion module and the lift and payload modules resembles that of a trained dolphin holding a glass of water steadily on his nose while swimming and leaping at an aquatic theme park. Gimbaled around a central point of cushioned air near the transmission contact, propulsion module and vehicle buoyancy enables transfer of only the forward propulsive movement minus the associated vibrations.

Shrouded Aquatic animal-like Propulsion: a significant aspect of the present invention is the application of biomimetics in the propulsion module, emulating aquatic animal-like hull motion and fin/fluke oscillation principles to enable major efficiency advantages over fixed-shape propeller and airplane wing alternatives. The present invention mimics buoyant aquatic animal body and tail motion to optimize propulsive motion per unit of expended energy. Partially compensating for the tremendous differences in operating environment for aquatic animals and aircraft, particularly between air and water density respectively, the shrouded tailfin/fluke magnifies the advantageous effects of fin/fluke shape and oscillation frequency and amplitude. In addition to the powerful biomimetic aquatic animal-like and bird-like burst of dispersed turbulent airflow during takeoff, fish/cetacean-motion propulsion efficiency is attained during cruise by maintaining boundary layer attachment over a much longer portion of the propulsive structure—unlike airplane wings and propellers where early boundary layer separation causes turbulent wake and vortices resulting in loss of efficiency in lift and propulsion.

Additionally the present invention's shrouded tailfin/fluke propulsion mimics the biomimetic principles employed by aquatic jet swimmers such as squid and octopus and by turbine and ducted fan engine nacelles to enhance propulsion. The present invention emulates propeller or turbine shroud or nacelle retention of propulsion force of the air that is expelled from the trailing edges and tips of propellers and turbine blades, creating a greater concentration of propulsive force. Retaining and compressing the tailfin/fluke thrust-force, especially at high oscillation frequency and amplitude, creates an augmented biomimetic pulsejet-like force that in turn creates greater efficiencies of expended energy and propulsion. A preferred embodiment of this shroud is for a central membrane wall to act as the shared internal opposing force field for a synchronized set of twin oscillating tailfin/flukes.

Directional Control: another function in the lift module is to provide roll and pitch-axis directional control. Most areas of the present invention that incorporate lifting gases comprise segments of gas-impregnated bubble wrap foam of varying cell sizes and thickness. Parallel non-foam nesting segments in each level of the lift module bellow or accordion up. In the core level of the lift module, each one of those segments of buoyant gas bubble wrap foam is independently compressible. These segments can morph due to mechanical compression by pulling the structure down, or by compressive pumping of the gas into the hollow spar system. The reverse of lift module compression is relaxing to its fail-safe buoyant expanded state. In the event of a loss of power or flight control in some way, the vehicle shape reverts to the safe buoyant state, a major safety factor. As the user may require, the upper expansion layers are positively inflated, either by heating air or vapor, or by released or adiabatically expanded excess lift gas volume from the spar system.

Within each lift module layer of wing structure, these areas of lift gas bubble wrap foam typically comprise two or three segments conformally parallel with the centerline of the vehicle. Control actuators or tethers on each side of the lift module individually morph these segments, either by pulling them down, by application of spar system vacuum, or by other means. Morphing the aft portion of one side's segments more or earlier than the other side's causes a wing warping effect that generates aileron turning force.

Directional control may also come from the propulsion actuation module oscillating in the dorsal plane by stiffening or relaxing one side or the other to give a directional (yaw) pull depending on degrees of differential empennage and/or tailfin/fluke deflection relative to the centerline. Shrouded embodiments have vector control for yaw and pitch inputs. Therefore, vehicle directional control can derive from both lift module and propulsion module morphing.

The same principles apply to pitch control. Present invention propulsion module frequency and amplitude of oscillations generate pitch and climb/descend vectors, particular when oscillating in the ventral plane. Similarly, by morphing the wing segments on both sides simultaneously, the shape change will generate pitch inputs. Likewise, changes in present invention module shapes will generate auxiliary speed control inputs. Relaxing both sides of the wing simultaneously will act as an air brake while increasing buoyancy.

The present invention, in scaled embodiments, may be used as follows: Civil roles—private and commercial passenger transport, cargo transport, promotional, camera, sightseeing, leisure and high adventure/extreme sports, sky lab, survey, ambulance, private and commercial fishing, agricultural spraying, utility line management, and ranching; Government roles—law enforcement, customs and immigration, area control, search and rescue, disaster relief, natural resource management; Paramilitary roles—Coast Guard, fishery protection/anti-piracy, counter-terrorism, sovereignty enforcement; Military roles—Airborne Early Warning (AEW), Anti-Submarine Warfare (ASW), Mine Countermeasures (MCM), Command, Control, Communications and Information (C3I), and Reconnaissance, Intelligence, Surveillance, and Target Acquisition (RISTA).

Launch: The present invention Personal Air Vehicle (PAV) embodiment may be housed in a standard R1-zone two-car single-door garage. The PAV in pre-flight mode has adjustable buoyancy, allowing for easy wheeled or un-wheeled ground movement of the present invention out into the driveway. An ultralight PAV embodiment may be strapped on like a backpack for ground takeoff (or airborne deployment from a jump aircraft) with the propulsion module mounted like a bicycle.

The user(s) may preload or wait until after boarding the PAV to add a compensating volume of lift gas to the lift module to achieve desired PAV buoyancy while simultaneously engaging the propulsion module. The desired speed and angle of liftoff will determine the amount of differential lift gas inflation in relation to available dynamic lift required before surface release. For a gradual, more horizontal up-glide, the user can release almost immediately and allow the differential lift, in conjunction with dynamic propulsion, to commence the flight. For more steep vertical liftoff, as might be required in an area of obstacles (trees, tall buildings, etc.) the user can delay release until achieving optimal buoyancy. Options for lift steam/hydrogen generation include both engine bleed air and auxiliary ground power units.

Liftoff, Climb and Transition to Cruise: The aerodynamic lifting body shape of the PAV, combined with lift-generating extended wings and propulsion module buoyancy, augment the buoyant lift component for climb and upward pitch angle as soon as the propulsion module is generating thrust. Upon up-gliding clear of obstacles, a decrease in pitch angle permits speed over the ground and rate of climb increases in exchange for reduced angle of climb to altitude. Compressing the lift module bellows or accordion expansion layers has the following main effects:

reduces aerodynamic drag, thereby

increasing dynamic lift effectiveness and

increasing airspeed;

reduces lift gas volume and thereby total buoyant lift;

increases pneumatic pressure in the lift module envelope and spar system, thereby

increasing wing and spar rigidity, thereby

further deploying the wings and

tightening the spine, thereby

moving aft-ward the locus of propulsion module oscillation, thereby

enabling higher tailfin/fluke oscillation frequency.

Variably compressing the lift module can involve combinations of:

mechanically closing the bellows using tethers and actuators

pumping lift gas from the core lift segment back into its skeletal system

cooling heated lift gas and

dumping overboard or reconstituting non-helium lift augmentation agents.

Cruise: throughout the morphing process, the vehicle remains maneuverable by means of both the gimbaled propulsion system and differential wing shaping. Top cruise speed is achieved by optimizing the locus and plane of oscillation for the propulsion module, in conjunction with optimal oscillation frequency, deflection/heave amplitude, and aspect ratio of the optimized tail. Directional control, mostly for course corrections and altitude management, requires very small yaw/roll-inducing deflection or wing shape changes in the lift and/or propulsion modules. During cruise flight, small wing shape changes, coordinated with propulsion module deflection shifts, are the primary directional control inputs. Variable empennage and tailfin/fluke oscillation deflection and tail shape changes are the primary inputs for slow flight maneuvering, while the combination of all inputs effects the greatest maneuverability, as with aquatic animals. Employing lift module shape changes in coordination with propulsion module oscillation variations biomimetically approximates the maneuverability advantages that aquatic animals and birds have over submarines and airplanes respectively.

Descent and transition to landing: nearing an urban destination, e.g. office building or home rooftop platform, in high-speed descent from cruise altitude, the user progressively restores previously compressed lift gas back to nearly launch buoyancy volume. Meanwhile, the user may also commence tapping from the engine or otherwise generating steam/hydrogen expansion of the lift module to not only serve as an air brake but to generate sufficient positive differential buoyancy for the powered desired angle of vertical landing. The PAV autonomous flight control precision adjustment of altitude and airspeed enables vehicle operation with high in-flight safety and reliability under much lower weather ceiling, visibility, and crosswind conditions than helicopter “point in space” or Copter ILS approaches. Approaching the platform, the user adjusts buoyancy for level off and touchdown, followed by further buoyancy adjustments as required for ground handling.

Parts of the present invention are listed in the following table:

| | |
|---|---|
| 010 | Air vehicle |
| 020 | Lift module |
| 030 | Payload module |
| 040 | Propulsion module |
| 050a | Front Wheel Assembly |
| 050b | Right Wheel Assembly |
| 050c | Left Wheel Assembly |
| 060 | Control system |
| 070 | Universal connection |
| 080 | Buoyant gas bubble wrap foam segment |
| 090 | Rearmost Tailfin/fluke |
| 100 | Engine Assembly |
| 110 | Heat Exchange Valve |
| 120 | Lifting Gas |
| 130 | Lifting Module Expansion Envelope |
| 140 | Spinal Stiffness Control System |
| 150 | Variable Tail Shape Control System |
| 160 | Propulsion Nacelle Shroud |
| 170 | Propulsion Module Spinal Structure |
| 180 | Hollow Flexible Telescoping Segments |
| 190 | Propulsion System Locus of Oscillation |
| 200 | Spinal Ribbon |
| 210 | Lift Module Deployable Pneumatic Telescoping Flexible Skeletal |
| | System |
| 220 | Lift Module Variable Inflation Bubble Wrap Foam Segment |
| 230 | Lift Module Control System |
| 240 | Skeletal spine |
| 250 | Skeletal spar |
| 260 | Stringer |
| 270 | Propulsion System Extension and Actuation System |
| 280 | Payload Shape-Controlling Skeletal System |
| 290 | Payload Cockpit |
| 300 | Payload Remote Control Apparatus |
| 310 | Payload Electrical System |
| 320 | Payload Surface Actuation System |
| 330 | Caster wheels |
| 340 | 2-way valve |
| 350 | Expansion level |
| 360 | Wing segment |
| 370 | Vacuum pump |
| 380 | Payload cabin |
| 390 | Payload cabin wall |
| 400 | Payload cabin aisle |
| 410 | Payload cabin seat |
| 420 | Oscillation locus |
| 430 | Control actuators |
| 440 | Mechanical battery |
| 450 | Pedal system |
| 460 | Air turbine generator |
| 470 | Foldable legs |
| 480 | Landing gear |
| 490 | Grasping mechanism |
| 500 | Remote controlled buoyant balloon |
| 510 | Hook or loop |
| 520 | Lightweight tether |
| 530 | Customized envelope material |
| 540 | On board spar holding tank |

Human Powered Vehicle (HPV): One embodiment of the present invention is the HPV. The feelings of safety and confidence engendered by the partially buoyant bubble wrap foam panels through the vehicle, combined with the quiet economical ease of use and freedom of movement above the ground, will lead to wide acceptance of the present invention HPV embodiment throughout the developed and developing world. The HPV propulsion module may incorporate a supplemental lightweight nylon spring mechanical battery power unit that can be continually recharged by in-flight pedaling motion of the user, augmented by an airborne wind-flow powered and lightweight air turbine generator. The user will typically precharge the mechanical battery (wind it up) on the ground before loading. The mechanical battery will therefore have a high store of kinetic energy available for throttle engagement for take off, or in other times of increased energy demand. This burst of takeoff energy, although expended rather quickly, is sufficient to attain prompt surface separation, buoyant flight, and low level winds escape speed. At higher altitude, cruising dynamic wing lift frees up energy demand to allow gradual rebuilding of the energy store during the rest of the flight, effectively recharging the mechanical battery through continuously variable low gear ratio pedaling and air turbine rotation.

Cetacean (whale/dolphin/porpoise) Flight: a novel method of endurance and range-extending flying possible with the present invention that is impractical in legacy aircraft is cetacean flight, e.g., porpoising energy management flight. This super-economy energy management Porpoise Flight profile significantly increases range and endurance while expending minimal motive energy. Because the present invention normal level flight mode provides optimal cruise speed performance, the slower climb/descend Porpoise Flight will most commonly be selected only for long-distance economy endurance travel within uncontrolled or low traffic airspace. Advanced navigation and traffic avoidance instruments make the profile useable in nearly all controlled airspace.

Mimicking how aquatic animals harvest propulsive energy by traversing underwater pressure gradients, the present invention has the unique capacity to harvest lift energy generated by adiabatic gas volume expansion and heat from solar exposure, from aerodynamic friction, and from internal/external combustion or turbine engines. Employing hybrid heating of the onboard buoyant lift gases (helium, air, and steam/hydrogen) to generate buoyancy into higher flight levels and airstreams (as do world-circling balloons), the present invention optimizes in-flight energy and directional control by combining latent/static lift with dynamic engine-generated lift. Porpoise-like up-gliding in hybrid buoyant/dynamic lift mode to pressure height flight level equilibrium, the present invention reverses vertical direction by morphing into an aerodynamic shape to enable a porpoise-like down-glide trade of altitude energy for speed and distance over the ground. This morphing is accomplished by drawing the expanded lift gas into the skeletal chambers, thereby deploying the wings to full swept extension, and by releasing steam/hydrogen and heated air. Adjusting the extended wings sweep for optimal lift per unit of drag down-glide efficiency, the present invention employs principles of soaring while enjoying the advantages of reliable buoyant lift over reliance on localized and variable thermal air columns. After optimizing the energy trade for distance allowed by the ambient conditions, the present invention reverses again to hybrid buoyant/dynamic lift mode for climb to a new equilibrium pressure height to repeat the porpoise down/up-glide profile.

The present invention is not restricted by equilibrium pressure height flight level, the maximum altitude to which airships can fly due to maximum adiabatic lift gas expansion within their rigid airframes. In addition to helium lift and dynamic wing lift, the present invention can exploit various hybridizations of other lift gases, e.g. steam/hydrogen, hot air, and ammonia. The present invention accommodates gas expansion not only as pneumatic pressure to deploy and stiffen the wings, but it can also pack lift gas into the hollow spar system, to a certain pressure. This pressurized lift gas serves as a ballast substitute for use during the descent and landing phases of flight, as does the water condensed from steam/hydrogen and collected in an onboard reservoir or dumped as desired. The present invention may carry the minimum possible helium to maintain partial or slightly negative buoyancy, using the hybrid lift gases to make up the difference for the required buoyant lift, with the remainder of flight lift generated dynamically. Excess lift gas in the skeletal system also serves as a source of rapid emergency backup lift for use in event of loss of dynamic lift.

To optimize the vehicle's equilibrium pressure height and operating altitude regime, steam/hydrogen is optionally employed within the present invention to inflate the lift module bellows to provide differential lift force. Beyond the partial buoyancy boost in the beginning, subsequent expansion due to climb, and intentional and solar heating, helium lift is augmented by steam/hydrogen for lift. So, in most cases involving lift module “compression” for enhancing aerodynamic shape, the user is actually reducing the expansion volume.

The user has the option of compressing the lift module gas at cruise altitude. The expansion of onboard lift gas naturally causes increases in pneumatic pressure within all three modules during climb. In addition to mechanical and aerodynamic forces, the present invention typically vents lift steam/hydrogen as the main component of lift module morphing. In addition to releasing the steam/hydrogen, the present invention allows condensation and natural cooling to reduce the effective lift while collecting moisture to the reservoir for subsequent steam/hydrogen generation. This extra water ballast is also welcome, and sustainable aloft due to dynamic lift, to aid in altitude control. Employing lift steam/hydrogen increases the volume of required lift module expansion by approximately one third for equivalent lift, but eliminates the daunting energy-intensive task of lift gas re-pressurization while maintaining a continual recyclable and variable source of buoyancy. Likewise, the present invention can modify total lift by heating or cooling the lift gas directly by tapping engine heat or otherwise generating steam/hydrogen condensate.

Rooftop Mooring: the present invention makes possible various capture and winch-down launch and recovery methods, impossible for fixed winged aircraft, improving on the winch hook method used by helicopters to recover in difficult weather onto an aircraft carrier deck.

For the present invention, a remotely controlled buoyant balloon may be signaled to release and carry upwards a lightweight hook or loop that is reeled down to the landing platform after connection with the vehicle. The lightweight tether, floating well above adjacent obstacles, has four lines connected to the four corners of the landing platform. Unlike the pendulum swing risks for helicopters landing with a single winch cable, the four tethers of the present invention system reel down simultaneously against positive buoyancy to optimize landing stability.

Urban Traffic Conduits—Still air, forced air, and vacuum channels: in urbanized areas, PAV traffic density will favor systems for air corridors and channels. In addition to airspace “highways in the sky,” transportation authorities may install large transparent conduits between high-density travel nodes, e.g., in Hong Kong between the commercial district on the island and the residential areas along the hillsides, possibly anchored between two tall buildings or onto purpose-built towers. The conduits will be of sufficient size to accommodate multiple levels and directions of traffic. For much less energy and public investment than currently devoted to highways, bridges and subways for surface vehicles, a lightweight polymer (very strong but flexible and long-lasting) conduit of tunnel shape and size would accommodate multiple lanes of present invention traffic on several vertical levels.

Designated for varying speeds, the conduit channels protect air vehicles inside from the external elements such as wind, extreme temperature, and precipitation, and may accommodate multi-vehicle configurations as described below. Since all vehicles in the conduit are buoyant, the conduit requires minimal structural load-bearing reinforcement. Present invention PAVs bumping against the conduit sides do not cause damage to the conduit or other same direction air vehicles. Gaps between channels allow for en route change of lanes or speeds. High-speed conduit lanes are effectively wind tunnels, with streams of air boosted by fans and venturi shape. The volume of vehicle traffic required to justify public funds to construct and operate these energy-conserving wind or vacuum-assisted conduits will be much lower than comparable legacy public transportation infrastructure investments. With such conduit wind boost in the desired travel direction, present invention buoyant vehicles need only deploy a sail-fin to exploit these speed and efficiency-enhancing tailwinds.

The most advanced conduit systems will imitate bank teller vacuum tube cartridge shuttle systems. Requiring more powerful fans to generate a vacuum (possibly multiples or derivatives of the same fan units powering the wind assist conduits), and requiring conduit installation with tighter tolerances and air vehicle standardized dimensions or add-on seals, the system will greatly increase present invention vehicle speed for those equipped with airtight seals compatible with the vacuum conduits.

Present invention embodiments to replace barges, trains and the like: another advantage of the present invention is the possibility of multiple connected vehicle travel. Airplanes generally cannot be safely attached to each other for multi-craft air travel. However, just as multiple buoyant barges attached to each other are all navigated by the one inhabited ship on water, and rail cars are moved more economically over land when attached in train to an engine, so present invention vehicles traveling to same destinations can enjoy significant financial and labor savings by train or barge mode linked air vehicle flight. Buoyant vehicles generate even greater proportional savings than the referenced surface groups of vehicles because buoyancy allows attachment to a high thrust vehicle that propels and navigates on behalf of all attached vehicles, saving engines, fuel, and crew costs. Likewise, multiple cargo lifters, for example, could be attached together to lift an outsized cargo that otherwise would have to be disassembled for component transport by individual lift vehicles. This linked vehicle feature allows for maximum fleet flexibility where the transport company does not need to invest in or manage payload for the mega-lifters that would be necessary to carry large single-ship loads.

Marine Commercial and Recreational Uses: another present invention use with significant market potential is aquatic applications, such as boating and fishing. This includes sport and commercial deep-sea fishing, ship to shore shuttle service for oil platforms, cruise ships and remote islands, maritime patrol and rescue, or marine biologists conducting research. Instead of enduring the resistance of high waves and slow surface speed suffered by legacy watercraft, the user can employ the present invention air vehicle, it being air and water tight and able to land and takeoff on water vertically.

Developing world rural populations, where personal travel distances are greater, resources more dispersed, and airspace less dense, may prove to be first adopters of the present invention as their leap-ahead technology primary means of personal and public transportation. Advances in inexpensive and widely accessible precision air traffic avoidance and winds, temperature, and pressure aloft awareness, along with autonomous flight controls, will lead to free-flight profiles more akin to those of birds and aquatic animals. These will in turn lead to improvements in flight reliability and efficiency, thereby filling the skies at last with manned and unmanned vehicles traveling as safely as do the aquatic animals and birds in their elements. This will free both urban and rural populations from the limitations of earthbound congested roads and airports.

Although the invention has been described herein with specific reference to a presently preferred and additional embodiments thereof, it will be appreciated by those skilled in the art that various modifications, deletions, and alterations may be made to such preferred embodiment without departing from the spirit and scope of the invention. Accordingly, it is intended that all reasonably foreseeable additions, modifications, deletions and alterations be included within the scope of the invention as defined in the following claims.

What is claimed is:

1. A morphing air vehicle comprising:
a. a lift module;
b. a propulsion module;
c. a payload module;
d. means for morphing said lift module;
e. means for morphing said propulsion module;
f. means for morphing said payload module;
g. means for biomimetic empennage and tailfin/fluke oscillation propulsion;
h. means for shrouding said oscillation propulsion module;
i. means for releasable attachment of said lift module, said propulsion module and said payload module;
j. means for enclosing lift gas in conformal large cell bubble wrap foam segments;
k. means for skeletal system lift gas deployment of air vehicle systems;
l. means for employing a mixture of multiple lift gases for buoyancy assistance to a dynamic lift air vehicle; and,
m. means for controlling morphing and biomimetic oscillation.

2. The morphing air vehicle as defined in claim 1, wherein said means for lift module morphing is comprised of an exterior flexible skin with a composite clamshell, and an interior comprised of skeletal spine and spars, control tethers, 2-way valves, compressible gas, and bubble wrap foam material operable for controlling lift gas, buoyancy, and aerodynamic shape.

3. A method of air flight utilizing the morphing air vehicle as defined in claim 1, said method comprising
a. Inclining the front of said air vehicle by extending the front wheel assembly;
b. Generating positive buoyancy within said air vehicle;
c. Generating forward movement of said air vehicle through biomimetic oscillation; and
d. Morphing the lift module, propulsion module and payload module to attain the flight characteristics desired.
